(19) United States
(12) Patent Application Publication
(10) Pub. No.: US 2016/0351185 A1
(43) Pub. Date: Dec. 1, 2016

(54) VOICE RECOGNITION DEVICE AND METHOD

(71) Applicant: HON HAI PRECISION INDUSTRY CO., LTD., New Taipei (TW)

(72) Inventor: Hai-Hsing LIN, New Taipei (TW)

(21) Appl. No.: 14/940,727

(22) Filed: Nov. 13, 2015

(30) Foreign Application Priority Data
Jun. 1, 2015 (TW) 104117693

(51) Int. Cl. G10L 15/06; G10L 15/07; G10L 15/22

(52) U.S. Cl. CPC G10L 15/063; G10L 15/22; G10L 15/07; G10L 2015/221; G10L 2015/0636; G10L 2015/0631; G10L 2015/0638

(57) ABSTRACT

A voice recognition method includes training all of voices stored in a first database when there is a new voice being stored into the first database, transferring the earliest stored voice in the first database to a second database when all of the voices in the first database have been trained, and training all of voices stored in the second database when the earliest stored voice in the first database is transferred to the second database.

### CROSS-REFERENCE TO RELATED APPLICATIONS

This application claims priority to Taiwanese Patent Application No. 104117693 filed on Jun. 1, 2015, the contents of which are incorporated by reference herein.

### FIELD

The subject matter herein generally relates to voice recognition technology, and particularly to a voice recognition device and a method thereof.

### BACKGROUND

Computers and devices can be implemented to include a voice recognition technology. The voice recognition technology can be implemented to perform functions on the device. Additionally, the voice recognition device can be configured to receive the data at the device and transmit the data to an external device, which processes the data.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of a voice recognition device of one embodiment.

FIG. 2 is a block diagram of sub-modules of the voice recognition device of FIG. 1.

FIG. 3 is a block diagram of a voice training interface of the voice recognition device of FIG. 1.

FIG. 4 is a block diagram of a voice recognition interface of the voice recognition device of FIG. 1.

FIG. 5 illustrates a flowchart of a voice training method which is a part of a voice recognition method.

FIG. 6 illustrates a flowchart of another part of a voice recognition method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

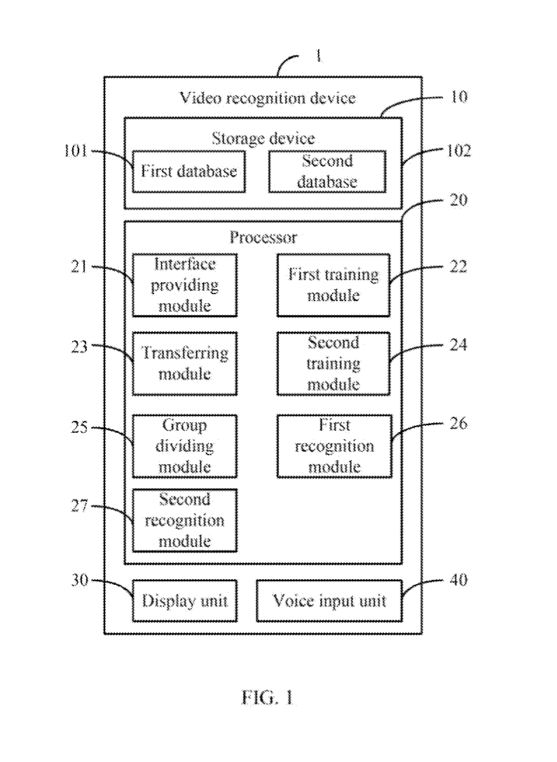

FIG. 1 illustrates a voice recognition device 1. The voice recognition device 1 is used for executing voice training and voice recognition, the voice training is executed for sampling and analyzing voices of speakers, the voice recognition is executed for recognizing an identity of a speaker. In the illustrated embodiment, the voice recognition device 1 can be a personal computer, a smart phone, a robot, a cloud server, or other electronic devices with functions of voice inputting and voice processing.

In the illustrated embodiment, the voice recognition device 1 can independently train or recognize an input voice. In another embodiment, the voice recognition device 1 can connect to the cloud server via Internet or Local Area Network, and request the cloud server to train or recognize the input voice. In yet another embodiment, the voice recognition device 1 can connect to the cloud server via Internet or Local Area Network, and request the cloud server to train the input voice and receive training results generated by the cloud server, then the voice recognition device 1 can recognize the input voice by itself.

The voice recognition device 1 includes, but is not limited to, a storage device 10, a processor 20, a display unit 30, and a voice input unit 40. The storage device 10 stores a first database 101 and a second database 102. The first database 102 stores a predetermined number of voices, a feature value of each voice, and an average voice feature value of each user. The second database 102 stores historical voice data which is not stored in the first database 101. The historical voice data also include a number of voices, the feature value of each voice, and the average voice feature value of each user, generated previously. In the illustrated embodiment, the number of voices stored in the first database 101 can be a default value, such as thirty, or other value set by the user, such as fifty. In the illustrated embodiment, each voice stored in the first database 101 and the second database 102 can be a voice document or a voice data package.

In at least one embodiment, the storage device 10 can include various types of non-transitory computer-readable storage mediums. For example, the storage device 10 can be an internal storage system, such as a flash memory, a random access memory (RAM) for temporary storage of information, and/or a read-only memory (ROM) for permanent storage of information. The storage device 10 can also be an external storage system, such as a hard disk, a storage card, or a data storage medium. The at least one processor 20 can be a central processing unit (CPU), a microprocessor, or other data processor chip that performs functions in the voice recognition device 1.

The display unit 30 displays a voice training result or a voice recognition result. The voice input unit 40 receives voices input by users. In the illustrated embodiment, the display unit 30 can be a touch screen, a liquid crystal display (LCD), a light-emitting diode (LED) display, or the like. The voice input unit 40 can be a microphone.

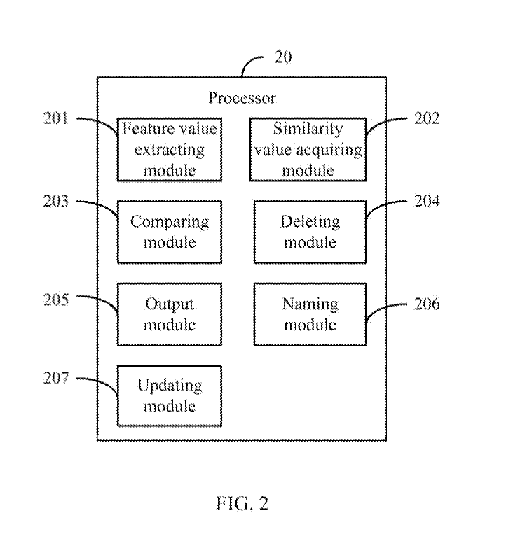

As illustrated in FIG. 1, the processor 20 includes an interface providing module 21, a first training module 22, a transferring module 23, a second training module 24, a group dividing module 25, a first recognition module 26, and a second recognition module 27. As illustrated in FIG. 2, the processor 20 further includes a feature value extracting module 201, a similarity value acquiring module 202, a comparing module 203, a deleting module 204, an output module 205, a naming module 206, and an updating module 207.

In the illustrated embodiment, the modules 201-207 are sub-modules which can be called by each of the modules 22-27. The modules 21-27 and the modules 201-207 can be collections of software instructions stored in the storage device 10 and executed by the processor 20. The modules 21-27 and the modules 201-207 also can include functionality represented as hardware or integrated circuits, or as software and hardware combinations, such as a special-purpose processor or a general-purpose processor with special-purpose firmware.

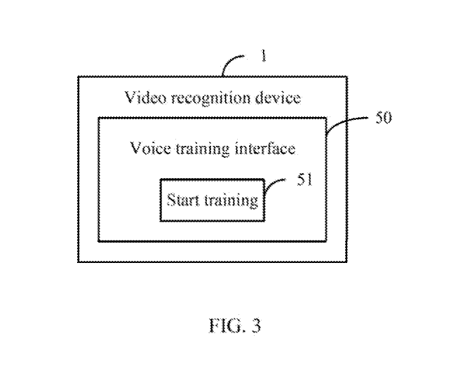

As illustrated in FIG. 3, the interface providing module 21 provides a voice training interface 50 in response to a voice training request of a user. In the illustrated embodiment, the user can log into the voice training interface 50 by inputting a username and a password. In other embodiments, the user can log into the voice training interface 50 by way of face recognition or fingerprint recognition. In the illustrated embodiment, the voice training interface 50 displays a “Start training” option 51 after the user logs into the voice training interface 50, and the user can start the voice training by clicking the “Start training” option 51. In other embodiments, the voice recognition device 1 can include a gravity sensor and a proximity sensor which are configured to detect when the user is close to the voice recognition device 1. For example, when a distance between a mouth of the user and the voice recognition device 1 is detected to be within a predetermined range, the voice recognition device 1 starts executing the voice training. Furthermore, the user also can start the voice training by speaking the words “Start training” via the voice input unit 40.

When there is a new voice being stored into the first database 101, the first training module 22 trains all of the voices stored in the first database 101. The first training module 22 trains all of the voices stored in the first database 101 by calling the modules 201-207, and the modules 201-207 train all of the voices in the first database 101 as follows.

The feature value extracting module 201 acquires a voice newly input by the user, stores the acquired voice into the first database 101, and extracts the feature value of the newly input voice. In the illustrated embodiment, the newly input voice can be the voice which is prerecorded by the user, or can be the voice currently input by the user via the voice input unit 40. A duration of each input voice is greater than a predetermined time length, the predetermined time length is a default value, such as fifteen seconds.

The similarity acquiring module 202 compares the feature value of the newly input voice with the average voice feature value of each user in the first database 101, acquires a number of similarity values according to the results of comparison, and selects a highest similarity value from the similarity values.

The comparing module 203 compares the highest similarity value with a predetermined high threshold (hereinafter “PHT”). In the illustrated embodiment, the PHT is used for determining whether the newly input voice needs to be trained, and the PHT can be a value set by the user or can be a default value.

When the highest similarity value is greater than the PHT, the deleting module 204 deletes the newly input voice from the first database 101. In the illustrated embodiment, when the highest similarity value is greater than the PHT, the first database 101 is already storing a voice which is sufficiently similar with the newly input voice, and this means that it is not necessary to store the newly input voice in the first database 101.

The output module 205 displays a message that the newly input voice is deleted on the display unit 30.

When the highest similarity value is less than or equal to the PHT, the naming module 206 names the newly input voice, and stores the named newly input voice into the first database 101. The highest similarity value being less than or equal to the PHT means that the first database 101 does not store voice which is similar with the newly input voice, and the newly input voice can obviously represent the voice feature of the user, therefore the newly input voice is needed to be trained.

In the illustrated embodiment, a format of the name of the newly input voice named by the naming module 206 is “name_n_time”. “Name” is the username used to log into the voice training interface 50 and “n” is a sequence number of the newly input voice in all of the voices stored in the first database 101 and the second database 102. For example, if the first database 101 has stored two voices of the user, and the second database 102 has stored three voices of the user, the newly input voice is the sixth voice, and the value of “n” is six. “Time” is an actual time when newly input voice is stored in the first database 101.

The updating module 207 extracts the feature values of all of the voices including the newly input voice, recalculates the average voice feature value of each user, and stores all of the feature values and the average voice feature values into the first database 101.

Furthermore, the comparing module 203 compares the highest similarity value with a predetermined low threshold (hereinafter “PLT”). In the illustrated embodiment, the PHT is used for determining whether the newly input voice can be recognized successfully, the PLT can be a value set by the user or can be a default value.

When the highest similarity value is greater than or equal to the PLT, the output module 205 displays a result that the newly input voice can be recognized and displays the highest similarity value on the display unit 30. In the illustrated embodiment, if the displayed similarity value is low, then although the newly input voice can be recognized, the similarities between the newly input voice and the voices stored in the first database 101 are low, that is, the voices of the user cannot be recognized accurately, and the user needs to do more voice trainings.

When the highest similarity value is less than the PLT, the output module 205 further displays a result that the newly input voice cannot be recognized and displays the highest similarity value on the display unit 30. In the illustrated embodiment, if the newly input voice cannot be recognized, the similarities between the newly input voice and the voices stored in the first database 101 are low, the user needs to do more voice trainings.

When all of the voices in the first database 101 have been trained, the transferring module 23 transfers an earliest stored voice in the first database 101 to the second database 102. As a result, the transferred voice is no longer stored in the first database 101.

When the earliest stored voice in the first database 101 is transferred to the second database 102, the second training module 24 trains all of the voices stored in the second database 102. In the illustrated embodiment, the second training module 24 trains the voices stored in the second database 102 in the same way as is done by the first training module 22 as described above.

Furthermore, the group dividing module 25 divides the voices stored in the first database 101 into a number of groups, and divides the voices stored in the second database 102 into a number of groups corresponding to the groups of the first database. The groups divided in the first database 101 are the same as the groups divided in the second database 102. For example, if the first database 101 includes groups A, B, and C, the second database 102 also includes groups A, B, and C.

In the illustrated embodiment, the group dividing module 25 can divide the voices of the users stored in the first database 101 and second database 102 into a number of groups according to an area or department in which each user is located. For example, group A stores the voices of New York users, the feature value of each voice of the New York users, and the average voice feature value of each New York user. Group B stores the voices of Los Angeles users, the feature value of each voice of the Los Angeles users, and the average voice feature value of each Los Angeles user.

When a group of the first database 101 stores a new voice, the first training module 22 further trains all of the voices in the group. When all of the voices in the group of the first database 101 have been trained, the transferring module 23 transfers the earliest stored voice in the first database 101 to a corresponding group of the second database 102. For example, if the transferred voice is stored in a group A of the first database 101, when transferred to the second database 102, the transferred voice is stored in the group A of the second database 102. When the earliest stored voice in the first database 101 is transferred to the corresponding group of the second database 102, the second training module 24 trains all of the voices in the corresponding group of the second database 102.

The feature value extracting module 201 further determines the group of the user according to the login information of the user, stores the newly input voice of the user into the group of first database 101, and extracts the feature value of the newly input voice. In the illustrated embodiment, the login information includes the username and the password, thus the feature value extracting module 201 can determine the group of the user according to the username of the user.

The similarity acquiring module 202 further compares the feature value of the newly input voice with the average voice feature value of each user in the group of the first database 101, and selects a highest similarity value from the acquired similarity values.

When the highest similarity value is less than or equal to the PHT, the naming module 206 further names the newly input voice as already described, and stores the named voice in the group of the first database 101.

The updating module 207 further extracts the feature values of all of the voices including the newly input voice, recalculates the average voice feature value of each user, and stores all of the feature values and the average voice feature values in the relevant group of the first database 101.

In the illustrated embodiment, the groups in the first database 101 and second database 102 can collect the voice data of users in the same group, such as the same area or the same department in a company. When the user needs to do voice training or voice recognition, the voice feature values of the user need only to be compared with the average voice feature values of each user in the corresponding group, thus less time is spent during the voice training or voice recognition.

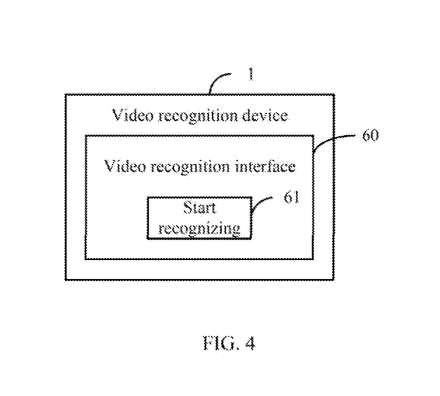

As illustrated in FIG. 4, the interface providing module 21 further provides a voice recognition interface 60 in response to a voice recognition request of the user. After logging into the voice recognition interface 60, the user can input a voice to be recognized via the voice input unit 40, then the voice recognition device 1 executes the voice recognition. In the illustrated embodiment, the voice recognition interface 60 can display a “Start recognizing” option 61 after the user logs into the voice recognition interface 60, and the user can start the voice recognition by clicking the “Start recognizing” option 61. In other embodiments, the user also can start the voice recognition by speaking the words “Start recognizing” via the voice input unit 40.

When a group of the first database 101 stores the new voice to be recognized, the first recognition module 26 recognizes an identity of the user who inputs the voice according to the group. The first recognition module 26 recognizes the identity of the user by calling the feature value extracting module 201, the similarity value acquiring module 202, the comparing module 203, and the output module 205, and the feature value extracting module 201, the similarity value acquiring module 202, the comparing module 203, and the output module 205 recognize the identity of the user in the following manner.

The feature value extracting module 201 acquires the voice to be recognized, and extracts the feature value of the voice to be recognized. In the illustrated embodiment, the voice to be recognized is input by the user in real-time via the voice recognition unit 40.

The similarity acquiring module 202 compares the feature value of the voice to be recognized with the average voice feature value of each user in the corresponding group of the first database 101, acquires a number of similarity values, and selects a highest similarity value from the similarity values.

The comparing module 203 compares the highest similarity value with a predetermined value. In the illustrated embodiment, the predetermined value is a threshold which is used for determining whether the identity of the user who inputs the voice can be recognized, the predetermined value is a default value.

When the highest similarity value is greater than or equal to the predetermined value, the output module 205 displays a result that the identity of the user who inputs the voice is recognized and displays the identity of the user on the display unit 30.

When the identity of the user is not recognized by the first recognition module 26, the second recognition module 27 recognizes the identity of the user according to a corresponding group of the second database 102. In the illustrated embodiment, the second recognition module 27 recognizes the identity of the user by calling the similarity value acquiring module 202, the comparing module 203, and the output module 205, and the similarity value acquiring module 202, the comparing module 203, and the output module 205 recognize the identity of the user in the following manner.

When the identity of the user is not recognized by the first recognition module 26, the similarity acquiring module 202 compares the feature value of the voice to be recognized with the average voice feature value of each user in the corresponding group of the second database 102, acquires a number of similarity values, and selects a highest similarity value from the similarity values.

The comparing module 203 compares the highest similarity value with a predetermined value. When the highest similarity value is greater than or equal to the predetermined value, the output module 205 displays a result that the identity of the user is recognized and displays the identity of the user on the display unit 30. When the highest similarity value is less than the predetermined value, the output module 205 displays a result that the identity of the user is not recognized on the display unit 30.

In the illustrated embodiment, the voice recognition device 1 can independently execute the voice training and the voice recognition by foregoing ways.

In one embodiment, the first database 101 and the second database 102 can be stored in the cloud server, the voice recognition device 1 can connect to the cloud server, and request the cloud server to execute the voice training and the voice recognition by foregoing ways. At this time, the modules 22-27 and the modules 201-206 can run on the cloud server, and the voice recognition device 1 can receive the input of the voice and execute the display of results.

In another embodiment, the voice recognition device 1 and the cloud server both store the first database 101 and the second database 102, the voice recognition device 1 can connect to the cloud server, and can request the cloud server to execute the voice training by foregoing ways, and receive the training results generated by the cloud server. the training results include the feature values of all of the voices and the average voice feature value of each user. The voice recognition device 1 executes the voice recognition according to the received training result. At this time, the modules 22-25, the modules 201-204, and the modules 206-207 can run on the cloud server, and the interface providing module 21, the first recognition module 26, the second recognition module 27, the feature value extracting module 201, the similarity value acquiring module 202, the comparing module 203, and the output module 205 can run on the voice recognition device 1.

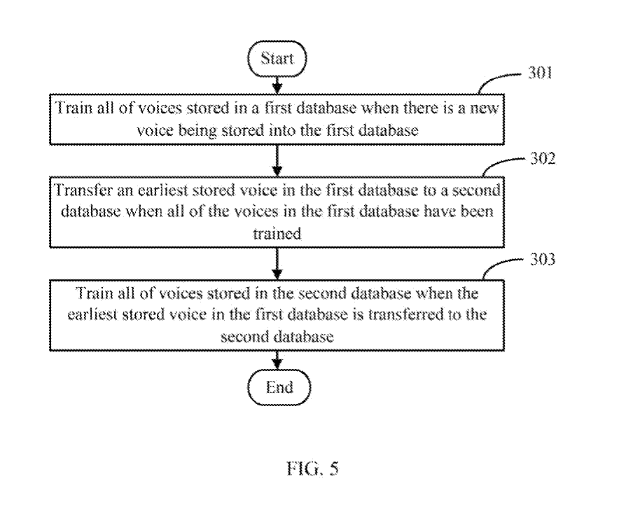

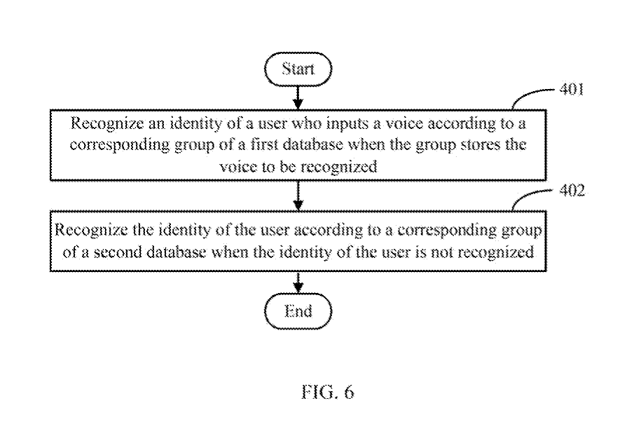

FIG. 5 illustrates a flowchart of voice training method which is a part of a voice recognition method. FIG. 6 illustrates a flowchart of another part of a voice recognition method. The voice training method and the voice recognition method are provided by way of examples, as there are a variety of ways to carry out the methods. The methods described below can be carried out using the configurations illustrated in FIGS. 1-4, for example, and various elements of these figures are referenced in explaining the example method. Each block shown in FIG. 5 and FIG. 6 represent one or more processes, methods, or subroutines carried out in the example methods. Furthermore, the illustrated order of blocks is by example only and the order of the blocks can be changed. Additional blocks may be added or fewer blocks may be utilized, without departing from this disclosure. The voice training example method can begin at block 301, and the voice recognition example method can begin at block 401.

At block 301, when there is a new voice being stored into a first database, a first training module trains all of the voices stored in the first database.

At block 302, when all of the voices in the first database have been trained, a transferring module transfers an earliest stored voice in the first database to a second database.

At block 303, when the earliest stored voice in the first database is transferred to the second database, a second training module trains all of the voices stored in the second database.

More specifically, the block 301 includes: a feature value extracting module acquires a voice input by a user, stores the acquired voice into the first database, and extracts the feature value of the newly input voice; a similarity acquiring module compares the feature value of the newly input voice with the average voice feature value of each user in the first database, acquires a number of similarity values according to the results of comparison, and selects a highest similarity value from the similarity values; a comparing module compares the highest similarity value with a predetermined high threshold; when the highest similarity value is greater than the predetermined high threshold, a deleting module deletes the newly input voice from the first database; an output module displays a message that the newly input voice is deleted on the display unit.

Furthermore, the block 301 includes: when the highest similarity value is less than or equal to the predetermined high threshold, a naming module names the newly input voice, and stores the named newly voice into the first database; an updating module extracts the feature values of all of the voices including the newly input voice, recalculates the average voice feature value of each user, and stores all of the feature values and the average voice feature values into the first database.

Furthermore, the block 301 includes: the comparing module compares the highest similarity value with a predetermined low threshold; when the highest similarity value is greater than or equal to the predetermined low threshold, the output module displays a result that the newly input voice can be recognized and displays the highest similarity value on the display unit; and when the highest similarity value is less than the predetermined low threshold, the output module further displays a result that the newly input voice cannot be recognized and displays the highest similarity value on the display unit.

Furthermore, the video recognition method includes: a group dividing module divides the voices stored in the first database into a number of groups, and divides the voices stored in the second database into a number of groups corresponding to the groups of the first database; when a group of the first database stores a new voice, the first training module trains all of the voices in the group; when all of the voices in the group of the first database have been trained, the transferring module transfers the earliest stored voice in the first database to a corresponding group of the second database; and when the earliest stored voice is transferred to the corresponding group of the second database, the second training module trains all of the voices in the corresponding group of the second database.

At block 401, when a group of the first database stores a new voice to be recognized, the first recognition module recognizes an identity of a user who inputs the voice according to the group of the first database.

At block 402, when the identity of the user is not recognized by the first recognition module, the second recognition module recognizes the identity of the user according to a corresponding group of the second database.

More specifically, the block 401 includes: the feature value extracting module acquires the voice to be recognized input by the user, and extracts the feature value of the voice to be recognized; the similarity acquiring module compares the feature value of the voice to be recognized with the average voice feature value of each user in the corresponding group of the first database, acquires a number of similarity values, and selects a highest similarity value from the similarity values; the comparing module compares the highest similarity value with a predetermined value; and when the highest similarity value is greater than or equal to the predetermined value, the output module displays a result that the identity of the user is recognized and displays the identity of the user on the display unit.

More specifically, the block 402 includes: when the identity of the user is not recognized by the first recognition module, the similarity acquiring module compares the feature value of the voice to be recognized with the average voice feature value of each user in the corresponding group of the second database, acquires a number of similarity values, and selects a highest similarity value from the similarity values.

Furthermore, the block 402 includes: the comparing module compares the highest similarity value with a predetermined value; when the highest similarity value is greater than or equal to the predetermined value, the output module displays a result that the identity of the user is recognized and displays the identity of the user on the display unit; and when the highest similarity value is less than the predetermined value, the output module further displays a result that the identity of the user is not recognized on the display unit.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A voice recognition device comprising:
a storage device configured to store a plurality of instructions, a first database, and a second database, wherein the first database is configured to store a predetermined number of voices, a feature value of each voice and an average voice feature value of each user, and the second database is configured to store historical voice data which is not stored in the first database;
at least one processor configured to execute the plurality of instructions, which cause the at least one processor to:
when there is a new voice being stored into a first database, train all of the voices stored in the first database;
when all of the voices in the first database have been trained, transfer an earliest stored voice in the first database to the second database; and
when the earliest stored voice in the first database is transferred to the second database, train all of the voices stored in the second database.

2. The voice recognition device according to claim 1, wherein the at least one processor is caused to:
acquire a voice input by a user, store the acquired voice into the first database, and extract the feature value of the newly input voice;
compare the feature value of the newly input voice with the average voice feature value of each user in the first database, acquire a plurality of similarity values according to the results of comparison, and select a highest similarity value from the plurality of similarity values;
compare the highest similarity value with a predetermined high threshold;
when the highest similarity value is greater than the predetermined high threshold, delete the newly input voice from the first database;
display a message that the newly input voice is deleted on a display unit;
when the highest similarity value is less than or equal to the predetermined high threshold, name the newly input voice and store the named voice into the first database; and
extract the feature values of all of the voices including the newly input voice, recalculate the average voice feature value of each user, and store all of the feature values and the average voice feature values into the first database.

3. The voice recognition device according to claim 2, wherein the at least one processor is further caused to:
compare the highest similarity value with a predetermined low threshold;
when the highest similarity value is greater than or equal to the predetermined low threshold, display a result that the newly input voice can be recognized and display the highest similarity value on the display unit; and
when the highest similarity value is less than the predetermined low threshold, display a result that the newly input voice cannot be recognized and display the highest similarity value on the display unit.

4. The voice recognition device according to claim 1, wherein the at least one processor is further caused to:
divide the voices stored in the first database into a plurality of groups;
divide the voices stored in the second database into a plurality of groups corresponding to the plurality of groups of the first database;
when a group of the first database stores a new voice, train all of the voices in the group;
when all of the voices in the group of the first database have been trained, transfer the earliest stored voice in the first database to a corresponding group of the second database; and
when the earliest stored voice in the first database is transferred to the corresponding group of the second database, train all of the voices in the corresponding group of the second database.

5. The voice recognition device according to claim 4, wherein the at least one processor is further caused to:
when a group of the first database stores a new voice to be recognized, recognize an identity of a user who inputs the voice according to the group of the first database; and
when the identity of the user is not recognized, recognize the identity of the user according to a corresponding group of the second database.

6. The voice recognition device according to claim 5, wherein the at least one processor is caused to:
acquire the voice to be recognized input by the user, and extract the feature value of the voice to be recognized;
compare the feature value of the voice to be recognized with the average voice feature value of each user in the corresponding group of the first database, acquire a plurality of similarity values, and select a highest similarity value from the plurality of similarity values;
compare the highest similarity value with a predetermined value; and
when the highest similarity value is greater than or equal to the predetermined value, display a result that the identity of the user is recognized and display the identity of the user on the display unit.

7. The voice recognition device according to claim 6, wherein the at least one processor is caused to:
when the identity of the user is not recognized, compare the feature value of the voice to be recognized with the average voice feature value of each user in the corresponding group of the second database, acquire a plurality of similarity values, and select a highest similarity value from the plurality of similarity values;
compare the highest similarity value with a predetermined value;
when the highest similarity value is greater than or equal to the predetermined value, display a result of the identity that the user who inputs the voice is recognized and display the identity of the user on the display unit; and
when the highest similarity value is less than the predetermined value, display a result that the identity of the user is not recognized on the display unit.

8. A voice recognition method comprising:
training all of voices stored in a first database when there is a new voice being stored into the first database;
transferring an earliest stored voice in the first database to a second database when all of the voices in the first database have been trained; and
training all of voices stored in the second database when the earliest stored voice in the first database is transferred to the second database.

9. The voice recognition method according to claim 8, wherein “training all of the voices in the first database” comprises:
acquiring a voice input by a user, storing the acquired voice into the first database, and extracting the feature value of the newly input voice;
comparing the feature value of the newly input voice with the average voice feature value of each user in the first database, acquiring a plurality of similarity values according to the results of comparison, and selecting a highest similarity value from the plurality of similarity values;
comparing the highest similarity value with a predetermined high threshold;
deleting the newly input voice when the highest similarity value is greater than the predetermined high threshold from the first database;
displaying a message that the newly input voice is deleted on a display unit;
naming the newly input voice, and storing the named voice into the first database when the highest similarity value is less than or equal to the predetermined high threshold; and
extracting the feature values of all of the voices including the newly input voice, recalculating the average voice feature value of each user, and storing all of the feature values and the average voice feature values into the first database.

10. The voice recognition method according to claim 9, wherein “training all of the voices in the first database” further comprises:
comparing the highest similarity value with a predetermined low threshold;
displaying a result that the newly input voice can be recognized and displaying the highest similarity value on the display unit, when the highest similarity value is greater than or equal to the predetermined low threshold; and
displaying a result that the newly input voice cannot be recognized and displaying the highest similarity value on the display unit when the highest similarity value is less than the predetermined low threshold.

11. The voice recognition method according to claim 8, further comprising:
dividing the voices stored in the first database into a plurality of groups;
dividing the voices stored in the second database into a plurality of groups corresponding to the plurality of groups of the first database;
training all of the voices in the group when a group of the first database stores a new voice;
transferring the earliest stored voice in the first database to a corresponding group of the second database when all of the voices in the group of the first database have been trained; and
training all of the voices in the corresponding group of the second database when the earliest stored voice in the first database is transferred to the corresponding group of the second database.

12. The voice recognition method according to claim 11, further comprising:
recognizing an identity of a user who inputs a voice according to a corresponding group of the first database when the group stores the new voice to be recognized; and
recognizing the identity of the user according to a corresponding group of the second database when the identity of the user is not recognized.

13. The voice recognition method according to claim 12, wherein “recognizing an identity of a user who inputs the voice to be recognized according to a corresponding group of the first database” comprises:
acquiring the voice to be recognized input by the user, and extracting the feature value of the voice to be recognized;
comparing the feature value of the voice to be recognized with the average voice feature value of each user in the corresponding group of the first database, acquiring a plurality of similarity values, and selecting a highest similarity value from the plurality of similarity values;
comparing the highest similarity value with a predetermined value; and
displaying a result that the identity of the user is recognized and displaying the identity of the user on the display unit when the highest similarity value is greater than or equal to the predetermined value.

14. The voice recognition method according to claim 13, wherein “recognizing the identity of the user according to a corresponding group of the second database” comprises:
comparing the feature value of the voice to be recognized with the average voice feature value of each user in the corresponding group of the second database when the identity of the user is not recognized, acquiring a plurality of similarity values, and selecting a highest similarity value from the plurality of similarity values;
comparing the highest similarity value with a predetermined value;
displaying a result that the identity of the user who inputs the voice is recognized and displaying the identity of the user on the display unit when the highest similarity value is greater than or equal to the predetermined value; and
displaying a result that the identity of the user is not recognized on the display unit when the highest similarity value is less than the predetermined value.
